(19) United States
(12) Patent Application Publication
(10) Pub. No.: US 2008/0308609 A1
(43) Pub. Date: Dec. 18, 2008

(54) BOND HEAD FOR A WIRE BONDER

(75) Inventor: Armin Felber, Luzern (CH)

Correspondence Address: MCCORMICK, PAULDING & HUBER LLP, CITY PLACE II, 185 ASYLUM STREET, HARTFORD, CT, 06103, US

(73) Assignee: Oerlikon Assembly Equipment AG, Steinhausen, Cham (CH)

(21) Appl. No.: 12/134,289

(22) Filed: Jun. 6, 2008

(30) Foreign Application Priority Data
Jun. 15, 2007 (CH) 976/07

(51) Int. Cl. B23K 1/06

(52) U.S. Cl. 228/1.1

(57) ABSTRACT

A bond head for a wire bonding comprises a platform which is movable in a horizontal plane and on which a rocker is arranged which is rotatable about a first horizontal axis. An ultrasonic transducer which is rotatably held about a second horizontal axis is fastened to the rocker. A linear motor is arranged close to the first horizontal axis, with which the rotational position of the ultrasonic transducer is adjustable relative to the rocker. A sensor supplies an output signal from which the rotational position of the ultrasonic transducer can be derived. A controller regulates the position of the linear motor and thus rotational position of the ultrasonic transducer. The controller is also configured to supply a predetermined current to the linear motor in order to generate the required bonding force during the bonding.

### PRIORITY CLAIM

Applicant hereby claims foreign priority under 35 U.S.C §119 from Swiss Application No. 976/07 filed Jun. 15, 2007, the disclosure of which is herein incorporated by reference.

### FIELD OF THE INVENTION

The invention concerns a bond head for a wire bonder.

### BACKGROUND OF THE INVENTION

Wire bonders are used for producing wire connections between a semiconductor chip and a substrate. Bond heads for wire bonders are known for example from EP 317787, EP 1098356, U.S. Pat. No. 7,159,751 or WO 2006036669. These bond heads comprise a platform which is movable in the horizontal x/y plane and on which a rocker is held which is rotatable about a horizontal axis. An ultrasonic transducer is fastened to the rocker, at whose one end a capillary is clamped. A wire clamp is further fastened to the rocker, which clamp is located above the capillary. The capillary is used for fastening the wire to a connection point of the semiconductor chip and to a connection point of the substrate and for guiding the wire between the two connection points. The wire is wound up on a wire coil and is supplied to the capillary from a wire feed apparatus, with the wire running through the wire clamp and a longitudinal bore of the capillary.

From U.S. Pat. No. 7,025,243a bond head is known in which the rocker is rotatable by means of a first motor about the horizontal axis and in which the wire clamp is rotatable by means of a second motor about the same horizontal axis, so that the distance between the wire clamp and the capillary is changeable.

From EP 802012 a bond head is known in which the ultrasonic transducer is fastened by means of a link structure to the rocker, with additional damping elements being provided in order to suppress undesirable vibrations.

From US 20060076390 abond head is known to which a sensor is fastened which supplies an output signal representative of predetermined vibrations of the bond head and in which at least one actuator is arranged between the horn and the rocker which enables a motion of the horn relative to the rocker. A control device calculates a control signal for the actuator from the output signal of the sensor and controls the actuator in order to eliminate the vibrations of the horn or at least to reduce the same. The actuator can perform only small movements in the range of a few micrometers on the one hand, but with a relatively high frequency on the other hand.

In order to fasten the wire to a connection point of the semiconductor chip or the substrate, the rocker is rotated about the horizontal axis until the wire portion protruding from the capillary touches the contact point. The further downward movement of the capillary is subjected to resistance, so that the so-called bond force builds up. When the capillary impinges on the connection point, a force momentum occurs which depends on the lowering speed of the capillary and the moment of inertia of the rocker.

### SUMMARY OF THE INVENTION

The invention is on the one hand based on the object to develop a bond head in which the wire clamp is movable relative to the capillary and on the other hand on the object to reduce the force momentum occurring during the impingement of the capillary on the connection point.

A bond head for a wire bonder comprises a platform which is movable in a horizontal plane and on which a rocker is arranged which is rotatable about a first horizontal axis. An ultrasonic transducer is fastened to the rocker, which transducer is rotatable about a second horizontal axis. A linear motor is arranged in accordance with the invention close to the first horizontal axis, with which the rotational position of the ultrasonic transducer is adjustable relative to the rocker. A sensor supplies an output signal from which the rotational position of the ultrasonic transducer can be derived. A controller to which the output signal of the sensor is supplied adjusts the position of the linear motor and thus the rotational position of the ultrasonic transducer. The controller is also arranged to supply the linear motor with a predetermined current in order to generate the required bond force during the bonding.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The drawings are not shown true to scale. In the drawings:

FIG. 1 shows a side view of a bond head in accordance with the invention;

FIGS. 2 to 4 show a top view of an ultrasonic transducer, and

FIG. 5 shows three diagrams.

### DETAILED DESCRIPTION OF THE PREFERRED EMBODIMENTS

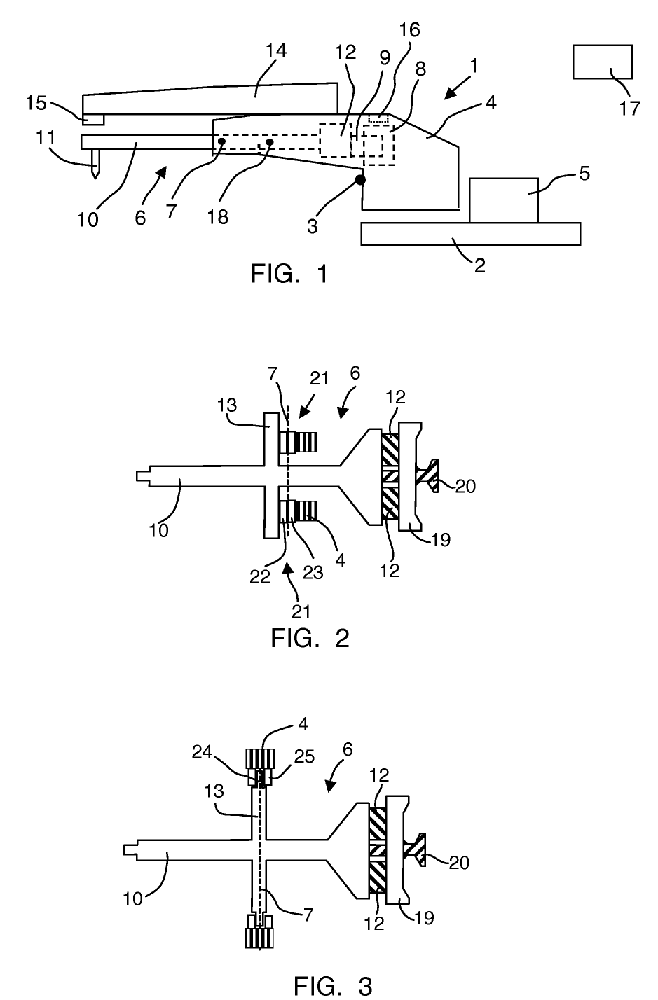

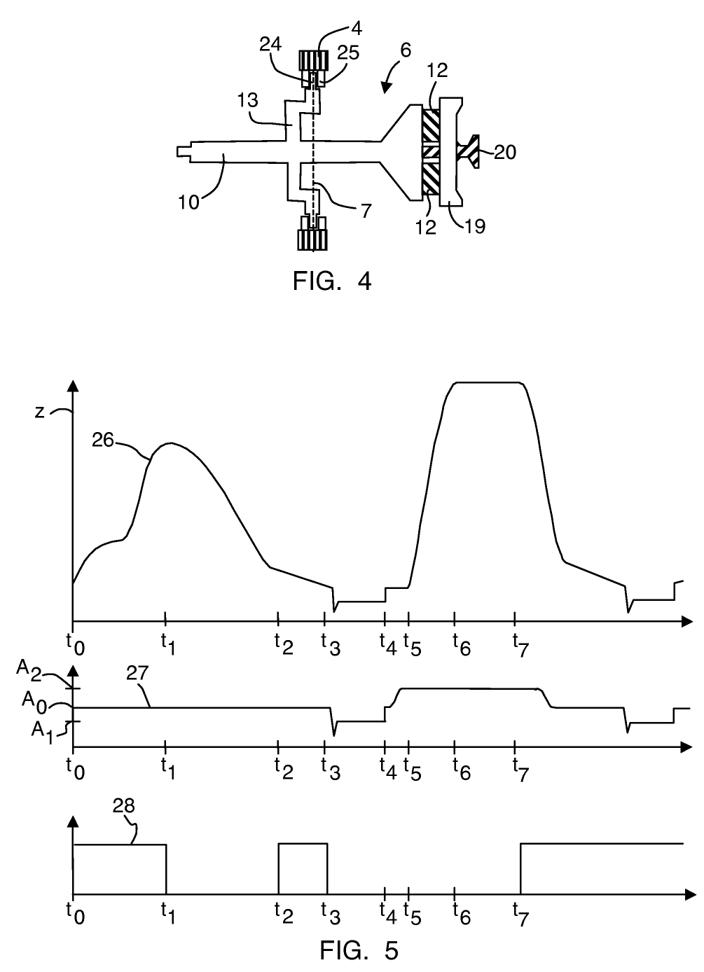

FIG. 1 schematically shows a side view of a bond head 1 in accordance with the invention. Bond head 1 comprises a platform 2 which is movable in a horizontal plane and on which are arranged a rocker 4 which is rotatable about a horizontal axis 3 and a first motor 5 for the rotation of the rocker 4 about the horizontal axis 3. An ultrasonic transducer 6 bears on the rocker 4 such that it is rotatable about a second horizontal axis 7. The stator 8 of a linear motor is fastened to the rocker 4 and the movable part of the linear motor (designated below as rotor 9) is fastened to the ultrasonic transducer 6 or vice-versa. The linear motor allows rotating the ultrasonic transducer 6 about the second horizontal axis 7, i.e. changing the rotational position of the ultrasonic transducer 6 relative to rocker 4. The ultrasonic transducer 6 comprises a horn 10, at the one end of which a capillary 11 is clamped, and at least one piezoelectric drive 12 in order to excite the ultrasonic transducer 6 to perform ultrasonic vibrations. Horn 10 comprises a flange 13 (FIG. 2) in order to fasten the ultrasonic transducer 6 to the rocker 4. A wire clamp 14 is fastened to the rocker 4, which wire clamp comprises two clamping jaws 15 arranged above the capillary 11. A sensor 16, from the output signal of which it is possible to derive the rotational position of the ultrasonic transducer 6 relative to the rocker 4, is attached at a suitable location to the rocker 4. The output signal of the sensor 16 is therefore representative of the rotational position of the ultrasonic transducer 6 relative to the rocker 4. The sensor 16 preferably measures the distance between the ultrasonic transducer 6, which also includes any part attached to it, as in the example the rotor 9, and a reference point on the rocker 4. Sensor 16 is a light barrier for example which is fastened to rocker 4, with a specific part of the ultrasonic transducer 6 or the linear motor blocking a portion of the light beam of the light barrier which depends on the rotational position of the ultrasonic transducer 6. Sensor 16 can also be a so-called PSD (“position sensitive device”) sensor or an eddy current sensor or any other suitable sensor. The output signal of sensor 16 is supplied to a controller 17 which adjusts the position of the linear motor. The linear motor allows for a travel of approximately 0.5 millimeters, but at least 0.3 millimeters. The linear motor can change the rotational position of the ultrasonic transducer 6, with such changes occurring relatively slowly, i.e the controller 17 works in a low-frequency band at frequencies in the range of 0 to a maximum of 200 Hz. The linear motor is therefore not capable of compensating the relatively high-frequency vibrations of the bond head which occur in the jerky starting and braking of the bond head and which are transmitted to the capillary 11.

FIG. 2 shows a schematic top view of an example for an ultrasonic transducer 6 which comprises two piezoelectric drives 12 which are separately controllable. The piezoelectric drives 12 are clamped between the horn 10 and a counter-part 19, namely with a screw 20.

According to the invention, the ultrasonic transducer 6 is held on the rocker 4 so as to be rotatable about the horizontal axis 7. The rotational bearing can be realized in many ways. Three examples will be explained below in closer detail.

### EXAMPLE 1

This example is shown in FIG. 2. A link joint 21 is arranged on both sides between the flange 13 of the ultrasonic transducer 6 and the rocker 4. The link joint 21 comprises two legs 22 and 23 for example, with flange 13 being fastened to the first leg 22 and the second leg 23 to the rocker 4. The first leg 22 can be deflected against the second leg 23 about the horizontal axis 7.

### EXAMPLE 2

This example is shown in FIG. 3. A bolt 24 is formed on the ends of flange 13 which is held in a ball bearing 25 fastened to the rocker 4.

### EXAMPLE 3

This example is shown in FIG. 3. The flange 13 is U-shaped and a bolt 24 is formed on the ends again which is held in a ball bearing 25 fastened to the rocker 4.

When the wire is fastened to a connection point, the ultrasonic transducer 6 is excited to perform ultrasonic vibrations by means of the piezoelectric drive 12, which vibrations usually comprise several vibration nodes and antinodes. The linear motor is a voice-coil motor, for example. The stator 8 is preferably a permanent magnet and the rotor 9 a coil. On the other hand, the stator 8 could be an electromagnet and the rotor 9 a permanent magnet. The stator 8 is fastened to rocker 4 and the rotor 9 to the ultrasonic transducer 6 or vice-versa. The following explanations relate to the preferred case that the rotor 9 is fastened to the ultrasonic transducer 6. They apply analogously for the case that the stator 8 is fastened to the ultrasonic transducer 6.

The rotor 9 fastened to the transducer 6 changes the vibration properties of the ultrasonic transducer 6. This must be taken into account as far as possible in the design of the ultrasonic transducer 6. The rotor 9 is advantageously directly integrated in the ultrasonic transducer 6. It is also possible on the other hand to glue the rotor 9 by means of a suitable adhesive to a part of the ultrasonic transducer 6. In this case, the rotor 9 is preferably fastened to the ultrasonic transducer 6 in a vibration node of the longitudinal ultrasonic vibrations.

The ultrasonic transducer 6 with the rotor 9 fastened to the same has other kinematic properties than the ultrasonic transducer 6 without rotor 9. In the production of a wire connection, the rocker 4 is rotated about the axis 3 in order to lift or lower the capillary 11. These rotations are subject to high accelerations. One important requirement is that the ultrasonic transducer 6 does not change its position relating to the rocker 4 or only changes the same to the lowest possible extent while the rocker 4 is rotated about the axis 3. When this requirement is fulfilled or is fulfilled at least approximately, the linear motor does not have to apply any force or only a very low one in order to keep constant the position of the ultrasonic transducer 6 relative to the rocker 4 during the rotations of the rocker 4 about the axis 3. The ultrasonic transducer 6 with the rotor 9 fastened to the same comprises a center of mass 18. In order to fulfill the required demand, the angular velocity ω₁ with which the ultrasonic transducer 6 rotates about the axis 7 must be equal to the angular velocity ω₂ with which the rocker 4 rotates about the axis 3. This can be achieved in such a way that the position of the axis 7 along the direction designated as x-direction is displaced from the position of the center of mass 18 in the direction towards the capillary 11. The optimal x-position of the axis 7 can be determined on the basis of mathematical equations which place in relation the two angular velocities w, and w₂ with the moments of inertia of the rocker 4 or the ultrasonic transducer 6, or they are determined experimentally. Because the axis 7 does not extend through the center of mass 18 of ultrasonic transducer 6 and rotor 9, the ultrasonic transducer 6 would rotate about the axis 7 under the influence of gravity during standstill of the rocker 4. The linear motor must therefore apply a low force during the standstill of the rocker 4 in order to keep constant the rotational position of the ultrasonic transducer 6 relative to the rocker 4.

In the production of a wire connection between a connection point of a semiconductor chip and a connection point of a substrate, whereby the substrate can also be a semiconductor chip, the wire end protruding from the capillary is molten at first into a ball. Thereafter, the wire ball is fastened to the connection point of the semiconductor chip by means of pressure and ultrasonic sound. The piezoelectric drive 12 applies ultrasonic sound to the horn 10. This process is called ball bonding. The wire is then pulled to the required wire length, formed into a wire loop and welded to the connection point of the substrate. This latter process part is called wedge bonding. After the fastening of the wire to the connection point of the substrate, the wire is torn off and the next bond cycle can begin. The possibility to rotate the ultrasonic transducer 6 held on the rocker 4 about the horizontal axis 7 allows performing the fastening of the wire to the connection point of the substrate according to a new method. The position of the horn 10 shall be understood as the rotational position of the horn 10 (or the rotational position of the ultrasonic transducer 6) relative to the rocker 4. The rotational position of the ultrasonic transducer 6 is definitely characterized by the position of the linear motor, with the position of the linear motor being defined for example as distance A between the rotor 9 and the sensor 16. Therefore the rotational position of the ultrasonic transducer 6 is the same as the position of the linear motor and is the same as the distance A. When the distance A increases, then the distance between the tip of the horn 10 and the wire clamp 14 decreases. Once the wire ball has been fastened to the connection point of the semiconductor chip, the following steps as explained below will be performed. These process steps will be illustrated with reference to FIG. 5. FIG. 5 shows three diagrams in function of time t, which are in the upper diagram 26 the rotational position of the rocker 4 (which is generally known in the art as z-height), in the middle diagram 27 the position of the linear motor as characterized by the distance A and in the bottom diagram 28 the state (open or closed) of the wire clamp 14.
1. The wire clamp 14 is open (time t₀). The wire is unthreaded to the required wire length. The ultrasonic transducer 6 is located in the middle rotational position according to a distance A₀ which can also be designated as the idle position.
2. The wire clamp 14 is closed (time t₁).
3. The bond head 1 moves the capillary 11 along a predetermined trajectory, at the end of which the capillary 11 impinges on the connection point of the substrate. The controller 17 adjusts the linear motor in such a way that the ultrasonic transducer 6 remains in the idle position. The last portion of the trajectory is the so-called search process during which the rocker 4 is rotated at constant speed about the axis 3 and the capillary 11 is thus lowered with constant speed until it touches the substrate. The wire clamp 14 is opened for this search process (time t₂).
4. As soon as the capillary 11 touches the substrate, i.e., the touchdown has occurred, the horn 10 is deflected in the direction towards the wire clamp 14. This leads to a rise in the control deviation of the controller 17, which is interpreted by the control software as touchdown. The wire clamp 14 is closed (time t₃), so that the wire cannot disappear upwardly into the capillary 11 when the wire should detach inadvertently during the bonding process.
5. As soon as the touchdown has been detected, the rotational movement of the rocker 4 is stopped. The controller 17 then supplies the linear motor with a current with a predetermined current intensity 11, and generates a predetermined bond force in this way. Since the horn 10 will bend slightly in this process, the distance A decreases to the value A₁. The harm 10 is then subjected simultaneously to ultrasonic sound and the wire is thus fastened to the connection point of the substrate, i.e., the wedge bond is formed.
6. As soon as the wedge bonding process is completed (time t₄), the controller 17 will adjust the position of the linear motor and thus the rotational position of the ultrasonic transducer 6 in such a way that the distance between the tip of horn 10 and the wire clamp 14 is reduced to a predetermined value, i.e., the distance A is increased to the value A₂. The wire clamp 14 is closed in this process. The length of the wire portion protruding from the capillary 11 is thus extended.
7. The rocker 4 is rotated as usual about the axis 3 (time t₅) in order to lift the capillary 11. The controller 17 will further adjust the position of the linear motor in such a way that the distance A will maintain the value A₂. During this rotational movement of the rocker 4, the wire is torn (immediately after time t₅). The wire portion protruding from capillary 11, the so-called “tail”, has the length A₂−A₀.
8. Once the rocker 4 has reached a predetermined height above the substrate (time t₆), the wire portion protruding from the capillary 11 is molten into a ball by means of an electrode subjected to high voltage. Once the wire ball has been formed (time t₇), the wire clamp 14 is opened first and the linear motor is controlled by controller 17 in such a way that the ultrasonic transducer 6 assumes the initial position again according to distance A₀.
   Now the next bonding cycle can begin again.

The relationship between the current intensity I₁ to be set in the above mentioned method step 5 and the bond force must be determined prior to the start of production process of the wire bonder by a calibrating measurement.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A bond head for a wire bonder, comprising:
a platform movable in a horizontal plane;
a rocker arranged on the platform and rotatable about a first horizontal axis;
an ultrasonic transducer held rotatably about a second horizontal axis on the rocker and comprising a horn with a tip on which a capillary can be clamped, with the second horizontal axis running at a predetermined distance parallel to the first horizontal axis;
a linear motor for regulating the rotational position of the ultrasonic transducer relative to the rocker, the linear motor comprising a stator and a rotor and being arranged close to the first horizontal axis, with either the stator being fastened to the rocker and the rotor to the ultrasonic transducer or the rotor to the rocker and the stator to the ultrasonic transducer;
a sensor delivering an output signal representative of said rotational position of the ultrasonic transducer relative to the rocker, and
a controller for regulating the linear motor based on the output signal of the sensor.

2. The bond head according to claim 1, wherein the ultrasonic transducer and the rotor or stator, respectively, fastened to the ultrasonic transducer have a common center of mass, wherein the second horizontal axis is situated between said center of mass and the tip of the horn.

3. The bond head according to claim 1, wherein the controller is configured to regulate in a first operating mode the position of the linear motor and thus the rotational position of the ultrasonic transducer and to supply the linear motor in a second operating mode with a current with a predetermined current intensity in order to generate a bond force.

4. The bond head according to claim 2, wherein the controller is configured to regulate in a first operating mode the position of the linear motor and thus the rotational position of the ultrasonic transducer and to supply the linear motor in a second operating mode with a current with a predetermined current intensity in order to generate a bond force.

5. The bond head according to claim 1, wherein the sensor measures a distance between the ultrasonic transducer and a reference point on the rocker.

6. The bond head according to claim 2, wherein the sensor measures a distance between the ultrasonic transducer and a reference point on the rocker.

7. The bond head according to claim 3, wherein the sensor measures a distance between the ultrasonic transducer and a reference point on the rocker.

8. The bond head according to claim 4, wherein the sensor measures a distance between the ultrasonic transducer and a reference point on the rocker.
